(19) United States
(12) Patent Application Publication
(10) Pub. No.: US 2024/0204566 A1
(43) Pub. Date: Jun. 20, 2024

(54) INTER-LAYER TWISTED COIL FOR WIRELESS POWER TRANSFER

(71) Applicant: Renesas Electronics America Inc., Milpitas, CA (US)

(72) Inventors: Sheng Yuan, Putuo District, Shanghai (CN); Jiangjian Huang, Milpitas, CA (US); Shangfeng Jiang, Chengdu,Sichuan (CN); Weiwei Zhou, Chengdu,Sichuan (CN)

(73) Assignee: Renesas Electronics America Inc., Milpitas, CA (US)

(21) Appl. No.: 17/801,149

(22) PCT Filed: Jul. 21, 2022
(86) PCT No.: PCT/CN2022/107029

§ 371 Date: Aug. 19, 2022

(51) Int. Cl. H02J 50/10; H01F 27/28; H01F 41/04

(52) U.S. Cl. CPC H02J 50/10; H01F 27/2804; H01F 41/041; H01F 2027/2809

(57) ABSTRACT

Apparatuses including a coil and methods of forming the coil are described. The coil can include a first coil layer including at least an inner strand and an outer strand. The coil can further include a second coil layer including at least an inner strand and an outer strand. The inner strand of the first coil layer can be connected to the outer strand of the second coil layer. The outer strand of the first coil layer can be connected to the inner strand of the second coil layer.

### BACKGROUND

The present disclosure relates in general to apparatuses and devices including an inter-layer twisted coil configuration.

Wireless power system can include a transmitter having a transmission coil and a receiver having a receiver coil. The transmission coil and the receiver coil can be brought close to one another to form a transformer that can facilitate inductive transmission of alternating current (AC) power. The transfer of AC power, from the transmitter to the receiver, can facilitate charging of a battery of the device including the receiver.

### SUMMARY

In one embodiment, an apparatus is generally described. The apparatus can include a first coil layer including at least an inner strand and an outer strand. The apparatus can further include a second coil layer including at least an inner strand and an outer strand. The inner strand of the first coil layer can be connected to the outer strand of the second coil layer. The outer strand of the first coil layer can be connected to the inner strand of the second coil layer.

In one embodiment, a device is generally described. The device can include a power rectifier configured to rectify alternating current (AC) power into direct current (DC) power. The device can further include a controller connected to the power rectifier. The controller can be configured to control the power rectifier. The device can further include a first coil layer connected to the power rectifier and configured to receive the AC power. The first coil layer can include at least an inner strand and an outer strand. The device can further include a second coil layer connected to the power rectifier and configured to receive the AC power. The second coil layer can include at least an inner strand and an outer strand. The inner strand of the first coil layer can be connected to the outer strand of the second coil layer. The outer strand of the first coil layer can be connected to the inner strand of the second coil layer.

In one embodiment, a method for constructing a coil of a device is generally described. The method can include forming a first coil layer that includes at least an inner strand and an outer strand. The method can further include forming a second coil layer that includes at least an inner strand and an outer strand. The method can further include connecting the inner strand of the first coil layer to the outer strand of the second coil layer. The method can further include connecting the outer strand of the first coil layer to the inner strand of the second coil layer.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram of an example system for wireless power transfer according to an embodiment.

FIG. 2A is a diagram showing components of a receiver that can implement inter-layer twisted coil for wireless power transfer in one embodiment.

FIG. 2B is a diagram showing an example coil configuration implementing inter-layer twisted coil for wireless power transfer in one embodiment.

FIG. 3A is a diagram showing an example coil layer that can implement inter-layer twisted coil for wireless power transfer in one embodiment.

FIG. 3B is a diagram showing connected coil layers that can implement inter-layer twisted coil for wireless power transfer in one embodiment.

FIG. 3C is a diagram showing multiple connected coil layers that can implement inter-layer twisted coil for wireless power transfer in one embodiment.

FIG. 4A is a diagram showing terminals of a receiver coil that can implement inter-layer twisted coil for wireless power transfer in one embodiment.

FIG. 4B is a diagram showing another perspective of the terminals of FIG. 4A in one embodiment.

FIG. 5 is a diagram showing an example receiver coil implementing inter-layer twisted coil for wireless power transfer in one embodiment.

FIG. 6 is a diagram showing an example embodiment of inter-layer twisted coil for wireless power transfer in one embodiment.

FIG. 7 is a flow diagram illustrating a process of constructing inter-layer twisted coil for wireless power transfer in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

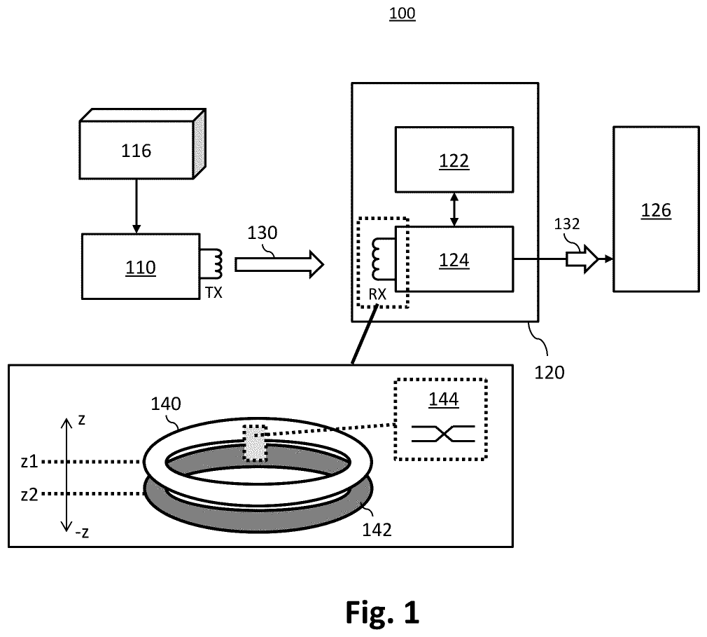

FIG. 1 is a block diagram of an example system 100 for wireless power transfer according to an embodiment. System 100 can include a transmitter 110 and a receiver 120 that are configured to wirelessly transfer power and data therebetween via inductive coupling. While described herein as transmitter 110 and receiver 120, each of transmitter 110 and receiver 120 may be configured to both transmit and receive power or data therebetween via inductive coupling.

Transmitter 110 is configured to receive power from one or more power supplies and to transmit AC power 130 to receiver 120 wirelessly. For example, transmitter 110 may be configured for connection to a power supply 116 such as, e.g., an adapter or a DC power supply. Transmitter 110 can include a coil TX, and can drive the coil TX to produce a magnetic field. Transmitter 110 can be configured to drive coil TX at a range of frequencies and configurations defined by wireless power standards, such as, e.g., the Wireless Power Consortium (Qi) standard, the Power Matters Alliance (PMA) standard, the Alliance for Wireless Power (A for WP, or Rezence) standard or any other wireless power standards.

Receiver 120 can be configured to receive AC power 130 transmitted from transmitter 110 and to supply the power to one or more loads 126 or other components of a destination device. Load 126 may comprise, for example, a battery charger that is configured to charge a battery of a destination device, such as a computing device, mobile device, mobile telephone, smart device, tablet, wearable device or any other electronic device that is configured to receive power wirelessly. In an embodiment, the destination device can include receiver 120. In other embodiments, receiver 120 may be separate from the destination device and connected to the destination device via a wire or other component that is configured to provide power to destination device.

Receiver 120 can include a controller 122 and a power rectifier 124. Controller 122 can include, for example, a processor, central processing unit (CPU), field-programmable gate array (FPGA) or any other circuitry that may be configured to control and operate power rectifier 124. Power rectifier 124 includes a coil RX and is configured to rectify power received via coil RX into a power type as needed for load 126. Power rectifier 124 is configured to rectify AC power received from coil RX into DC power 132 which may then be supplied to load 126.

As an example, when receiver 120 is placed in proximity to transmitter 110, the magnetic field produced by coil TX induces a current in coil RX of power rectifier 124. The induced current causes AC power 130 to be inductively transmitted from transmitter 110 to power rectifier 124. Power rectifier 124 receives AC power 130 and converts AC power 130 into DC power 132. DC power 132 is then provided by power rectifier 124 to load 126.

Transmitter 110 and receiver 120 are also configured to exchange information or data, e.g., messages, via the inductive coupling of the power driver of transmitter 110 and power rectifier 124. For example, before transmitter 110 begins transferring power to receiver 120, a power contract may be agreed upon and created between receiver 120 and transmitter 110. In another example, in response to receiver 120 being brought in proximity to transmitter 110, e.g., close enough such that a transformer may be formed by coil TX and coil RX to allow power transfer, receiver 120 may be configured to initiate communication by sending a signal to transmitter 110 that requests a power transfer. In such a case, transmitter 110 may respond to the request by receiver 120 by establishing the power contract or beginning power transfer to receiver 120, e.g., if the power contract is already in place. Transmitter 110 and receiver 120 may transmit and receive communication packets, data or other information via the inductive coupling of coil TX and coil RX. In some embodiments, communication between transmitter 110 and receiver 120 can occur before power transfer stage using various protocols such as near field communication (NFC), Bluetooth, etc.

In one embodiment, the coil RX of receiver 120 can include a plurality of layers of coils (e.g., at least two layers of coils), such as a first coil layer 140 (“layer 140”) and a second coil layer 142 (“layer 142”). In one embodiment, first layer 140 can be arranged on a first plane z1 and second layer 142 can be arranged on a second plane z2, where first plane z1 and second plane z2 are parallel two-dimensional planes. First layer 140 and second layer 142 can be adjacent to one another in a direction (e.g., z-direction, or vertical direction) perpendicular to the first plane z1 and the second plane z2. To be described in more detail below, the plurality of layers of coils, among coil RX, can be connected to one another using a configuration 144. Configuration 144 can be an inter-layer twisted configuration where an inner strand of first layer 140 is connected to an outer strand of second layer 142, and an inner strand of second layer 142 is connected to an outer strand of first layer 140. An inner strand can be a strand of wire that is closer to a center of a loop formed by a layer of coil (e.g., first layer 140 or second layer 142) when compared to the outer strand of the same layer of coil. As a result of connecting first layer 140 to second layer 142 using configuration 144, a total length of strands of wires on first layer 140 and second layer 142 can be balanced.

In an aspect, a receiver coil of a wireless power receiver can be constructed using multistrand wires (e.g., Litz wires, or wire including multiple strands). Utilization of multistrand wires can reduce skin depth effect, where skin depth effect is a tendency for alternating electric current (AC) to be displaced from the center of a wire to its surface. The plurality of strands can have different lengths due to the shape of the receiver coil. For example, if the receiver coil includes two strands of wires, such as an inner strand and an outer strand, that are arranged in parallel paths around a center to form a loop (e.g., circular loop, rectangular loop, or other loop shapes), then the inner strand (e.g., strand closer to the center) will be shorter in length, than the outer strand (e.g., strand further from the center). The difference in length can cause the plurality of strands to experience different magnetic flux created by the alternating current created from AC power being received by the receiver coil. For example, the outer strand can experience more magnetic flux than the inner strand due to the outer strand occupying more area of the receiver coil (e.g., longer length). The difference in magnetic flux being experienced by the different size (e.g., different length) strands can cause loop current to be induced between the strands, and this induced loop current can be converted to heat, thus increasing a temperature of the receiver. Therefore, the configuration 144 described herein can balance the lengths of strands on different layers of coils, leading to a reduction of difference between magnetic flux experienced by different strands in a receiver coil.

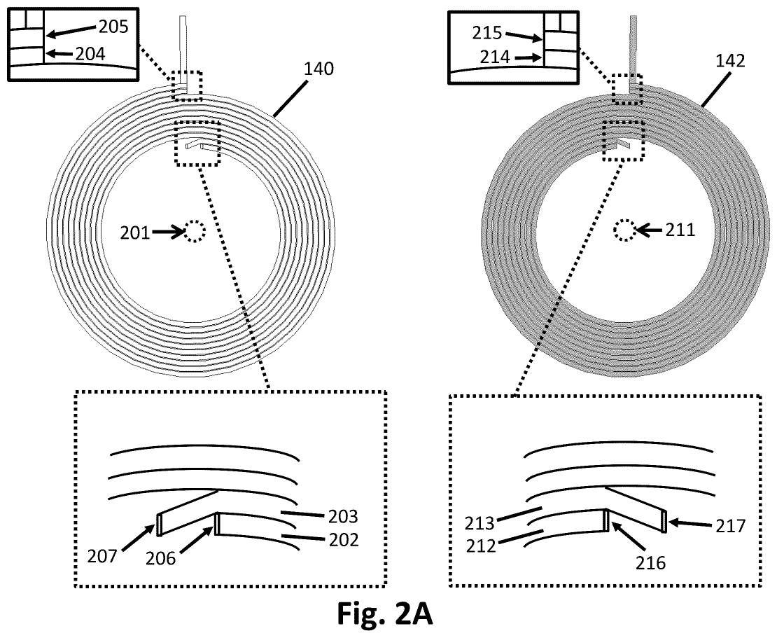

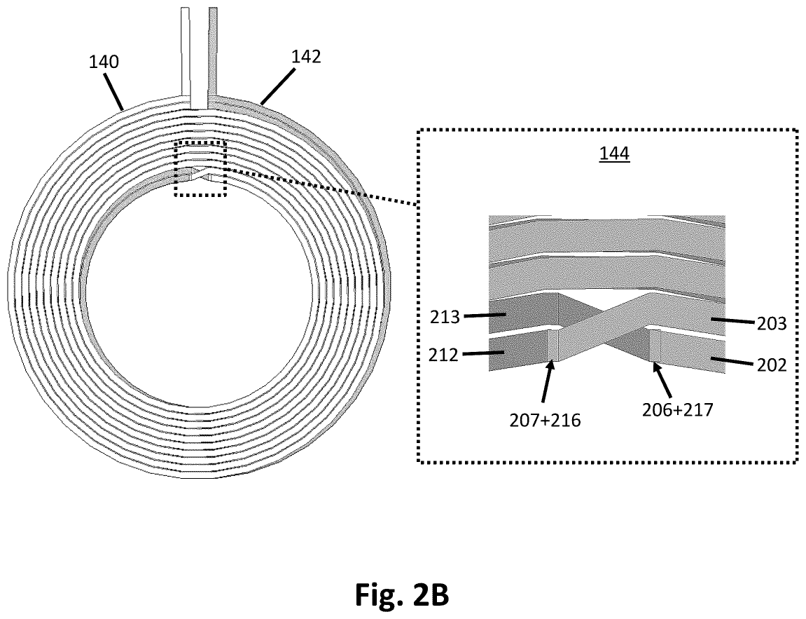

FIG. 2A is a diagram showing components of a receiver that can implement inter-layer twisted coil for wireless power transfer in one embodiment. An example of first layer 140 and second layer 142 of the coil RX, of FIG. 1, are shown in FIG. 2A. In one embodiment, first layer 140 and second layer 142 can be flexible printed circuits (FPCs). Construction of first layer 140 and second layer 142 using FPCs can allow the first layer 140 and second layer 142 to have arbitrary shapes and/or sizes. In an example shown in FIG. 2A, first layer 140 and second layer 142 can each form a loop around centers 201, 211, respectively. Center 201 can be a point on first plane z1 (see FIG. 1) and center 211 can be a point on second plane z2 (see FIG. 1). First layer 140 and second layer 142 can form loops of different shapes, such as circular (e.g., see FIG. 2A), rectangular, or other arbitrary shapes.

First layer 140 can include at least two strands of wires (“strands”), such as an inner strand 202 and an outer strand 203. Inner strand 202 can be a strand among first layer 140 that is closer to a center 201 of the loop formed by first layer 140 when compared to outer strand 203. Inner strand 202 can have a length that spans from an end 204 to an end 206. Outer strand 203 can have a length that spans from an end 205 to an end 207. Inner strand 202 and outer strand 203 can be arranged in parallel paths around center 201 to form a loop on first plane z1.

Second layer 142 can include at least two strands of wires (“strands”), such as an inner strand 212 and an outer strand 213. Inner strand 212 can be a strand among second layer 142 that is closer to a center 211 of the loop formed by second layer 142 when compared to outer strand 213. Inner strand 212 can have a length that spans from an end 214 to an end 216. Outer strand 213 can have a length that spans from an end 215 to an end 217. Inner strand 212 and outer strand 213 can be arranged in parallel paths around center 211 to form a loop on second plane z2. In one embodiment, inner strand 202 and inner strand 212 can have approximately the same length, and outer strand 203 and outer strand 213 can have approximately the same length.

FIG. 2B is a diagram showing configuration 144 (see FIG. 1), where configuration 144 can be realized by connecting end 207 of outer strand 203 to end 216 of inner strand 212, and by connecting end 206 of inner strand 202 to end 217 of outer strand 213. As a result of these connections, a first total strand of wire having a first length spanning from end 204 to end 215, via ends 206, 217 can be formed, and a second total strand of wire having a second length spanning from end 205 to end 214, via ends 207, 216 can be formed. In an example, inner strand 202 can have a length of X and inner strand 212 can have a length of X′, where a difference between X and X′ can be within a first percentage (e.g., 0.1%, 0.5%, 1%, etc.). Outer strand 203 can have a length of Y and outer strand 213 can have a length of Y′, where a difference between Y and Y′ can be within a second percentage (e.g., 0.1%, 0.5%, 1%, etc.). Under the connections of configuration 144, the length of the first total strand can be approximately X+Y′ and the second total strand can be approximately X′+Y. A difference between the lengths of the first and second total strands can be based on a combination of the first and second percentages. For example, the difference between the lengths of the first and second total strands can be a sum of first and second percentages. The connection of configuration 144 allows the first length of the first total strand to be approximately identical to the second length of the second total strand. Hence, the configuration 144 can balance the lengths of strands on layers 140, 142 leading to a reduction of difference between magnetic flux experienced by different strands in the coil RX.

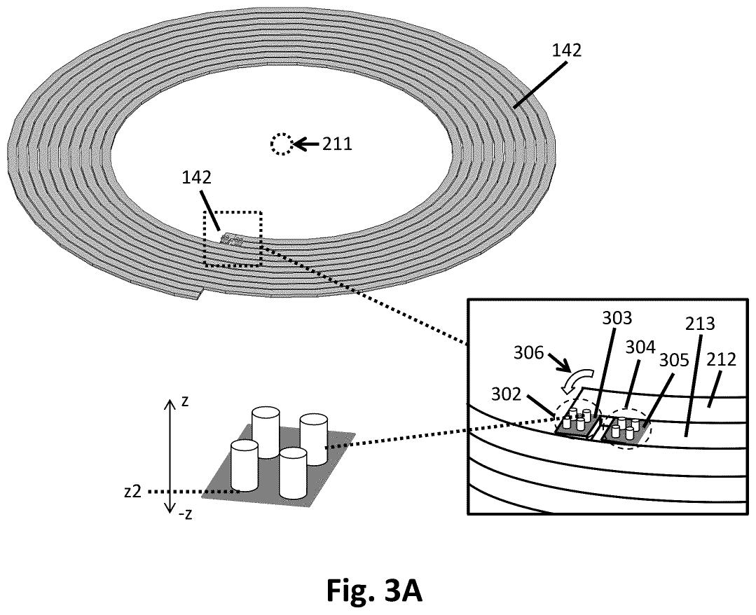

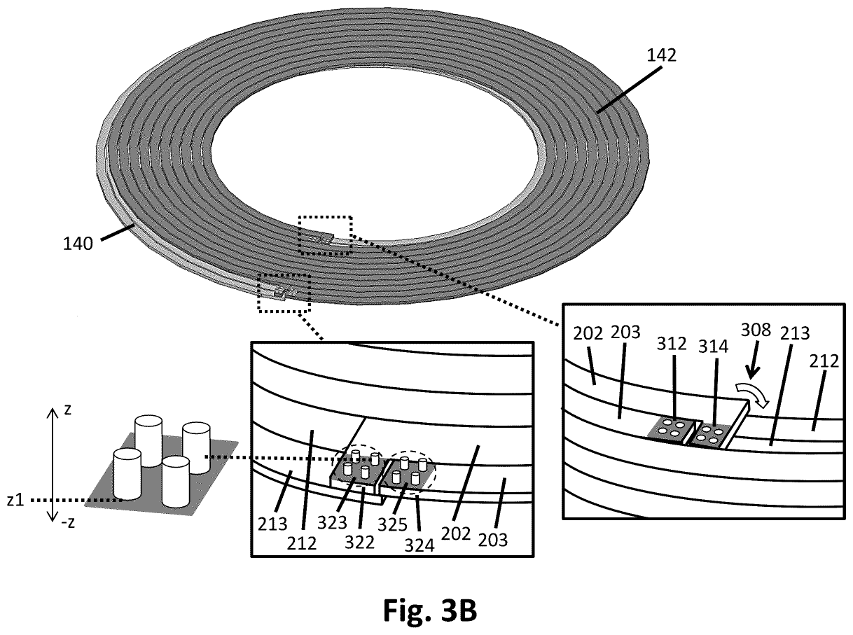

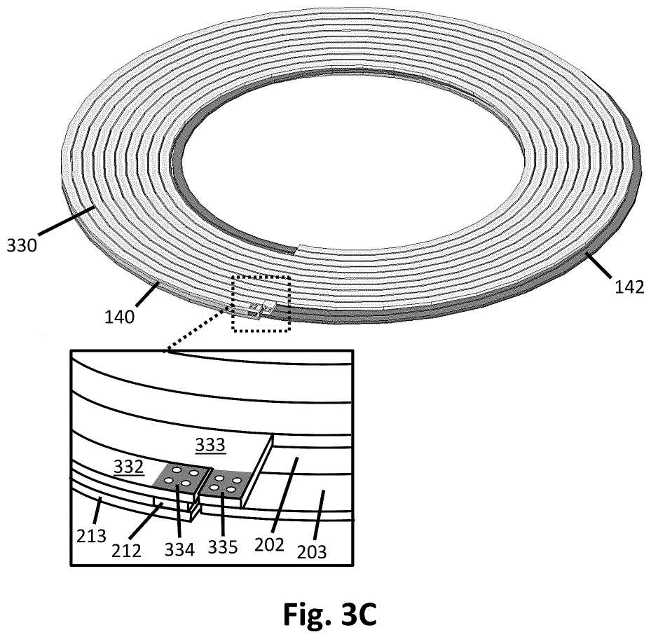

FIG. 3A is a diagram showing an example coil layer that can implement inter-layer twisted coil for wireless power transfer in one embodiment. In FIG. 3A, a set of contacts 302 can be bonded to a portion 303 (see shaded area on inner strand 212) of inner strand 212 in layer 142. A set of contacts 302 can be bonded to a portion 305 (see shaded area on outer strand 213) of outer strand 213 in layer 142. The contacts 302, 304 can be conductive structures, such as metal vias, bonding pads, solder bumps, or other types of contacts made of conductive materials. Contacts 302, 304 can protrude in the z-direction, such that contacts 302, 304 can be inserted into openings (e.g., holes), or recesses, of another coil layer (e.g., layer 140) on top of layer 142 (e.g., positioned in the z-direction relative to layer 142) to form configuration 144 (see FIGS. 1, 2A, and 2B). In order to form configuration 144, inner strand 212 can curve, or bend, in a direction 306 that is away from center 211 such that portion 303 can align with an outer strand of another coil layer (e.g., outer strand 203 of layer 140).

In an example shown in FIG. 3B, contacts 302 of FIG. 3A can be connected to outer strand 203 of layer 140 by, for example, being inserted into openings in a portion 312 (see shaded area on outer strand 203) of outer strand 203. Also shown in FIG. 3B, contacts 304 of FIG. 3A can be connected to inner strand 202 of layer 140 by, for example, being inserted into openings in a portion 314 (see shaded area on inner strand 202) of inner strand 202. The connection of contacts 302, 304 to outer strand 203 and inner strand 202, respectively, forms configuration 144. In order to form configuration 144, inner strand 202 of layer 140 can curve, or bend, in a direction 308 that is away from center 201 such that portion 314 can align with portion 305 of outer strand 213 of layer 142.

In one embodiment, configuration 144 can include more than two coil layers. To connect another coil layer on, for example, layer 140, a set of contacts 322 can be bonded to a portion 323 (see shaded area on outer strand 203) of outer strand 203 in layer 140. A set of contacts 324 can be bonded to a portion 325 (see shaded area on inner strand 202) of inner strand 202 in layer 140. The contacts 322, 324 can be conductive structures, such as metal vias, bonding pads, solder bumps, or other types of contacts made of conductive materials. Contacts 322, 324 can protrude in the z-direction, such that contacts 322, 324 can be inserted into openings (e.g., holes), or recesses, of another coil layer on top of layer 140 (e.g., positioned in the z-direction relative to layer 140) to form configuration 144.

In an example shown in FIG. 3C, contacts 322 of FIG. 3B can be connected to an outer strand 332 of a layer 330 by, for example, being inserted into openings in a portion 334 of outer strand 332 (see shaded area on outer strand 332). Also shown in FIG. 3C, contacts 324 of FIG. 3B can be connected to an inner strand 333 of layer 330 by, for example, being inserted into openings in a portion 335 of inner strand 333 (see shaded area on inner strand 333). The connection of contacts 322, 324 to outer strand 332 and inner strand 333, respectively, forms a third coil layer in configuration 144. In order to form configuration 144, inner strand 333 of layer 330 can curve, or bend, in a direction that is away from a center 331 such that portion 335 can align with portion 325 of outer strand 203 of layer 140.

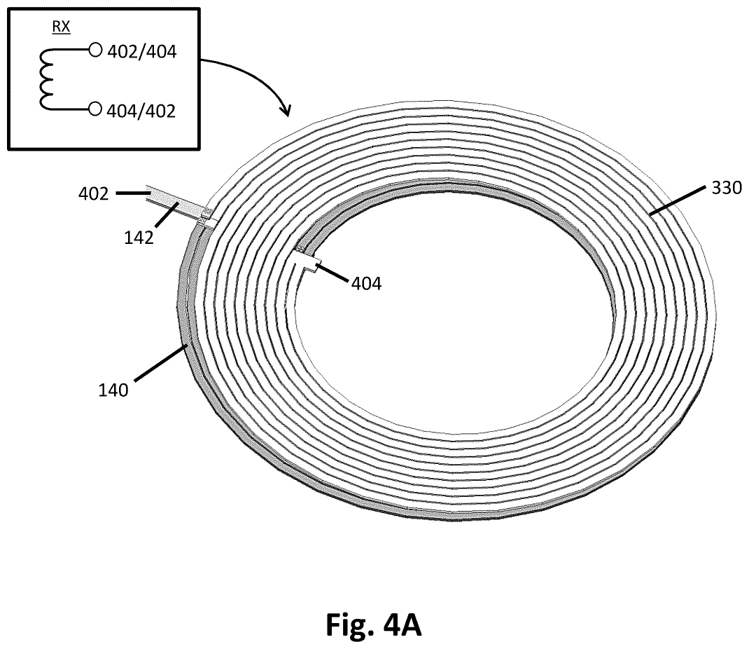

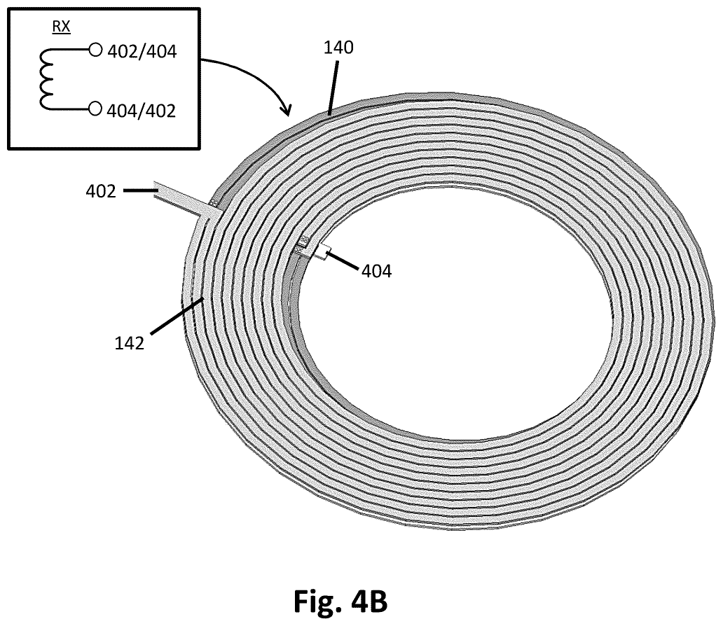

FIG. 4A and FIG. 4B are diagrams showing terminals of a receiver coil that can implement inter-layer twisted coil for wireless power transfer in one embodiment. In one embodiment, the coil RX (see FIG. 1) can include two terminals, such as a terminal 402 and a terminal 404, that can connect coil RX to power rectifier 124. FIG. 4A shows a top perspective view of coil RX, where coil RX includes three coil layers 140, 142, and 330 in a stacked configuration (e.g., arranged along z-direction shown in FIG. 1). In FIG. 4A, terminal 402 can be a part of layer 142 and terminal 404 can be a part of layer 330. In another embodiment, terminal 404 can be a part of layer 142 and terminal 402 can be a part of layer 330. FIG. 4B shows a bottom perspective view of coil RX.

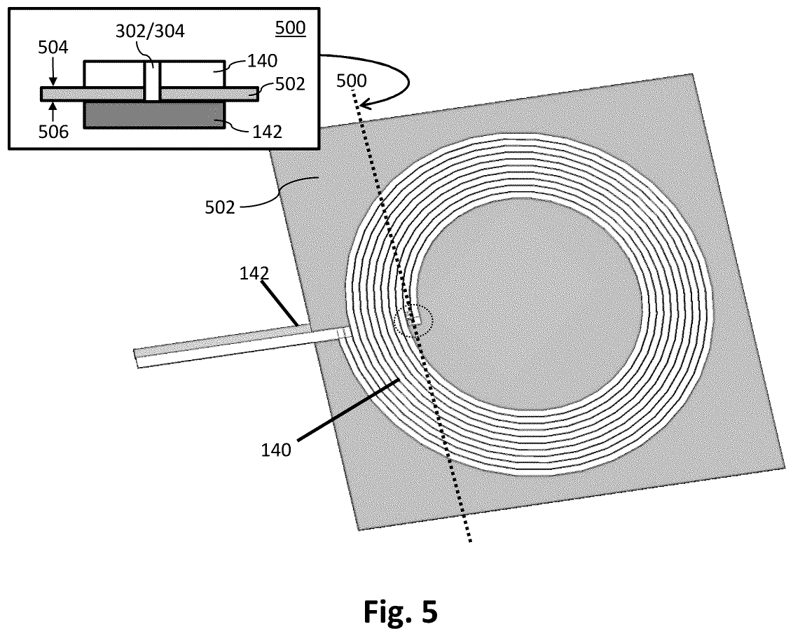

FIG. 5 is a diagram showing an example receiver coil implementing inter-layer twisted coil for wireless power transfer in one embodiment. In one embodiment, configuration 144 can include a layer of substrate between every pair of coil layers. For example, a coil configuration having three coil layers (e.g., FIG. 3C) can include two layers of substrate—a first substrate between layers 140, 142, and a second substrate between layers 140, 330. In an example shown in FIG. 5, configuration 144 includes two coil layers 140, 142 and a layer of substrate 502 is situated between layers 140, 142. Substrate 502 can be, for example, a layer of dielectric materials or other types of nonconductive materials. In one embodiment, layer 140 can be a FPC printed on one surface 504 of substrate 502 and layer 142 can be another FPC printed on another surface 506 of substrate 502, where surface 504 and surface 506 can be opposite from one another. In a cross sectional area 500 shown in FIG. 5, contacts 302 (or 304) bonded on layer 142 can be threaded through substrate 502 to be connected to layer 140.

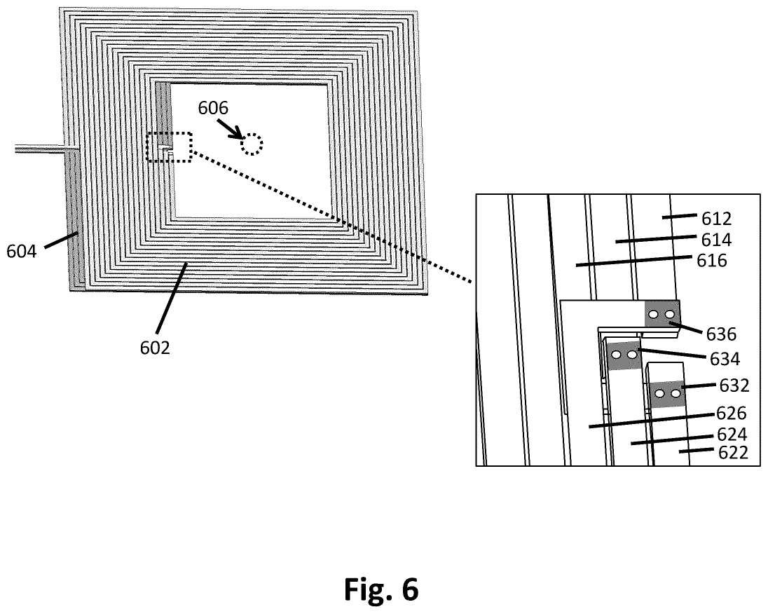

FIG. 6 is a diagram showing an example embodiment of inter-layer twisted coil for wireless power transfer in one embodiment. A coil configuration 600 shown in FIG. 6 can be implemented as the coil RX shown in FIG. 1. Coil configuration 600 can include a first coil layer 602 and a second coil layer 604. First coil layer 602 and second coil layer 604 can be flexible printed circuits (FPCs). Construction of first coil layer 602 and second coil layer 604 using FPCs can allow the first coil layer 602 and second coil layer 604 to have arbitrary shapes and/or sizes. For example, first coil layer 602 and second coil layer 604 can form a rectangular loop around a center 606.

First coil layer 602 can include three strands of wires (“strands”), such as strands 622, 624, 626. Strand 622 can be a strand among first coil layer 602 that is closer to center 606 when compared with strands 624, 626. Strand 626 can be a strand among first coil layer 602 that is further from center 606 when compared with strands 622, 624. Strands 622, 624, 626 can be arranged in parallel paths around center 606 to form a first loop on a first plane (e.g., z1 in FIG. 1).

Second coil layer 604 can include three strands of wires (“strands”), such as strands 612, 614, 616. Strand 612 can be a strand among second coil layer 604 that is closer to center 606 when compared with strands 614, 616. Strand 616 can be a strand among second coil layer 604 that is further from center 606 when compared with strands 612, 614. Strands 612, 614, 616 can be arranged in parallel paths around center 606 to form a second loop on a second plane (e.g., z2 in FIG. 1).

To form configuration 144 (see FIG. 1), strand 622 of first coil layer 602 can be connected to strand 616 of second coil layer 604, strand 624 of first coil layer 602 can be connected to strand 614 of second coil layer 604, and strand 626 of first coil layer 602 can be connected to strand 612 of second coil layer 604.

For a coil with N strands of wires, an i-th strand (e.g., i=1, . . . , N) can be connected to an (N+1-i)-th strand to form configuration 144, where i=1 corresponds to a strand that is closest to a center (e.g., centers 201, 211 in FIG. 2A or center 606 in FIG. 6), and i=N corresponds to a strand that is furthest from the center.

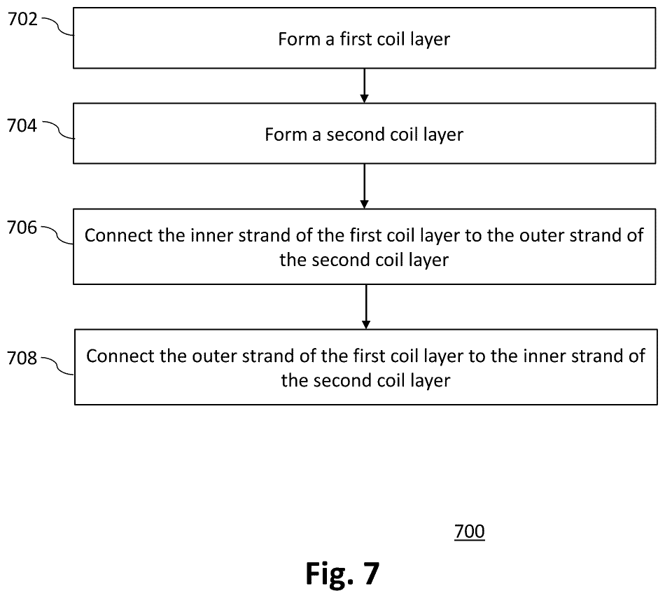

FIG. 7 is a flow diagram illustrating a process 700 of constructing inter-layer twisted coil for wireless power transfer in one embodiment. The process can include one or more operations, actions, or functions as illustrated by one or more of blocks 702, 704, 706, and/or 708. Although illustrated as discrete blocks, various blocks can be divided into additional blocks, combined into fewer blocks, eliminated, or performed in parallel, depending on the desired implementation.

Process 700 can be performed for constructing a coil of a device, such as a receiver coil of a wireless power receiver. Process 700 can begin at block 702. At block 702, a first coil layer can be formed, where the first coil layer can include at least an inner strand and an outer strand. Process 700 can proceed from block 702 to block 704. At block 704, a second coil layer can be formed, where the second coil layer can include at least an inner strand and an outer strand. In one embodiment, the first coil layer can be arranged on a first plane and the second coil layer can be arranged on a second plane. The first coil layer can be positioned to be adjacent to the second coil layer in a direction perpendicular to the first plane and the second plane.

Process 700 can proceed from block 704 to block 706. At block 706, the first inner strand of the first layer of coil can be connected to the second outer strand of the second layer of coil. Process 700 can proceed from block 706 to block 708. At block 708, the first outer strand of the first layer of coil can be connected to the second inner strand of the second layer of coil. In one embodiment, the connection of the inner strand of the first coil layer with the outer strand of the second coil layer forms a first total strand having a first length, and the connection of the outer strand of the first coil layer with the inner strand of the second coil layer forms a second total strand having a second length equivalent to the first length. In one embodiment, the inner strand of the first coil layer can be connected to the outer strand of the second coil layer by using a first set of contacts to connect the inner strand of the first coil layer to the outer strand of the second coil layer, and the outer strand of the first coil layer can be connected to the inner strand of the second coil layer by using a second set of contacts to connect the inner strand of the first coil layer to the outer strand of the second coil layer.

In one embodiment, the first coil layer and the second coil layer can be flexible printed circuits (FPCs). A FPC can include a metallic layer of traces (e.g., copper) bonded to a dielectric layer (e.g., polyimide) or substrate. The metallic layer of traces can be bonded to the dielectric layer using adhesive materials, or other bonding methods such as vapor deposition, etc. The metallic layer can be covered with a protective layer (e.g., gold or solder). Forming the first layer of coil and the second layer of coil can include printing patterns of the first layer of coil and the second layer of coil on dielectric materials. For example, photoresist coated panels can be overlayed with patterns of the first coil layer and the second coil layer, and the overlayed photoresist coated panels can be exposed with collimated UV light to transfer the patterns to production panels. The patterns can be chemically etched using specialized thin core handling equipped conveyorized systems. High speed, high precision, small hole capable, drilling systems can be used for creating required hole patterns in the production panels, or laser based systems can be used for ultra-small hole requirements. An FPC can be connected to another FPC using conductive contact structures, such as vias, solder bumps, metal bonding pads, and/or other types of conductive or metal contacts. Alignment and lamination process can be performed to package multiple FPCs as the receiver coil.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a first coil layer including at least an inner strand and an outer strand; and
a second coil layer including at least an inner strand and an outer strand, wherein:
the inner strand of the first coil layer is connected to the outer strand of the second coil layer; and
the outer strand of the first coil layer is connected to the inner strand of the second coil layer.

2. The apparatus of claim 1, wherein the first coil layer and the second coil layer are flexible printed circuit (FPC) coils.

3. The apparatus of claim 1, wherein the first coil layer and the second coil layer are parts of a wireless power receiver.

4. The apparatus of claim 1, wherein:
the first coil layer is arranged on a first plane;
the second coil layer is arranged on a second plane; and
the first coil layer and the second coil layer are adjacent to one another in a direction perpendicular to the first plane and the second plane.

5. The apparatus of claim 4, wherein:
the inner strand and the outer strand of the first coil layer are arranged in a parallel path, on the first plane, around a point on the first plane to form a first loop; and
the inner strand and the outer strand of the second coil layer are arranged in a parallel path, on the second plane, around a point on the second plane to form a second loop.

6. The apparatus of claim 1, wherein:
the connection of the inner strand of the first coil layer with the outer strand of the second coil layer forms a first total strand having a first length; and
the connection of the outer strand of the first coil layer with the inner strand of the second coil layer forms a second total strand having a second length equivalent to the first length.

7. The apparatus of claim 1, wherein the first coil layer and the second coil layer are configured to receive AC power from a wireless power transmitter.

8. The apparatus of claim 1, wherein:
the outer strand of the first coil layer is longer than the inner strand of the first coil layer, and experiences more magnetic flux than the inner strand of the first coil layer; and
the outer strand of the second coil layer is longer than the inner strand of the second coil layer, and experiences more magnetic flux than the inner strand of the second coil layer.

9. A device comprising:
a power rectifier configured to rectify alternating current (AC) power into direct current (DC) power;
a controller connected to the power rectifier, the controller being configured to control the power rectifier;
a first coil layer connected to the power rectifier and configured to receive the AC power, wherein the first coil layer includes at least an inner strand and an outer strand; and
a second coil layer connected to the power rectifier and configured to receive the AC power, wherein the second coil layer includes at least an inner strand and an outer strand, and wherein:
the inner strand of the first coil layer is connected to the outer strand of the second coil layer; and
the outer strand of the first coil layer is connected to the inner strand of the second coil layer.

10. The device of claim 9, wherein the first coil layer and the second coil layer are flexible printed circuit (FPC) coils.

11. The device of claim 9, wherein the controller, the power rectifier, the first coil layer, and the second coil layer are parts of a wireless power receiver.

12. The device of claim 9, wherein:
the first coil layer is arranged on a first plane;
the second coil layer is arranged on a second plane; and
the first coil layer and the second coil layer are adjacent to one another in a direction perpendicular to the first plane and the second plane.

13. The device of claim 12, wherein:
the inner strand and the outer strand of the first coil layer are arranged in a parallel path, on the first plane, around a point on the first plane to form a first loop; and
the inner strand and the outer strand of the second coil layer are arranged in a parallel path, on the second plane, around a point on the second plane to form a second loop.

14. The device of claim 9, wherein:
the connection of the inner strand of the first coil layer with the outer strand of the second coil layer forms a first total strand having a first length; and
the connection of the outer strand of the first coil layer with the inner strand of the second coil layer forms a second total strand having a second length equivalent to the first length.

15. The device of claim 9, wherein the first coil layer and the second coil layer are configured to receive AC power from a wireless power transmitter.

16. The device of claim 9, wherein:
the outer strand of the first coil layer is longer than the inner strand of the first coil layer, and experiences more magnetic flux than the inner strand of the first coil layer; and
the outer strand of the second coil layer is longer than the inner strand of the second coil layer, and experiences more magnetic flux than the inner strand of the second coil layer.

17. A method for constructing a coil of a device, the method comprising:
forming a first coil layer that includes at least an inner strand and an outer strand;
forming a second coil layer that includes at least an inner strand and an outer strand;
connecting the inner strand of the first coil layer to the outer strand of the second coil layer; and
connecting the outer strand of the first coil layer to the inner strand of the second coil layer.

18. The method of claim 17, further comprising:
arranging the first coil layer on a first plane;
arranging the second coil layer on a second plane; and
positioning the first coil layer adjacent to the second coil layer in a direction perpendicular to the first plane and the second plane.

19. The method of claim 17, wherein:
the connection of the inner strand of the first coil layer with the outer strand of the second coil layer forms a first total strand having a first length; and
the connection of the outer strand of the first coil layer with the inner strand of the second coil layer forms a second total strand having a second length equivalent to the first length.

20. The method of claim 17, wherein:
connecting the inner strand of the first coil layer to the outer strand of the second coil layer comprises using a first set of contacts to connect the inner strand of the first coil layer to the outer strand of the second coil layer; and
connecting the outer strand of the first coil layer to the inner strand of the second coil layer comprises using a second set of contacts to connect the inner strand of the first coil layer to the outer strand of the second coil layer.
